(19) United States
(12) Patent Application Publication
(10) Pub. No.: US 2014/0101994 A1
(43) Pub. Date: Apr. 17, 2014

(54) Conformable Display Stand Apparatus and Method

(71) Applicants: Loren Shapiro, Needham, MA (US); Mark Glynn, Shrewsbury, MA (US)

(72) Inventors: Loren Shapiro, Needham, MA (US); Mark Glynn, Shrewsbury, MA (US)

(21) Appl. No.: 13/652,599

(22) Filed: Oct. 16, 2012

(51) Int. Cl. A47G 33/12; B23P 11/02; F16M 13/00

(52) U.S. Cl. 47/40.5; 248/523; 29/505

(57) ABSTRACT

A base (and method) for display of a substantially vertical member having a supporting generally cylindrical member, adapted to provide adequate lateral stability to permit the vertical member to remain upright when exposed to lateral forces, to accept and retain liquid, and to allow the liquid to come into contact with the lower end of the cylindrical member. The cylindrical member is retained within the base by interference fit with a member comprised of an expanding, preferably plastic, foam which is initially in an unexpanded state, and is caused to expand after the cylindrical member is introduced into the base.

### BACKGROUND OF THE INVENTION

In many households and public spaces it is a tradition to display a coniferous plant at holiday times coinciding with the Winter Solstice (sometimes referred to as a “Christmas Tree”, “Holiday Tree”, “Chanukah Bush” or by any number of alternative appellations.) While, in a fully renewable and environmentally sound manner, many such displays use a living plant with its root system undamaged, thus permitting the replanting after display, other manners of display involve cutting the trunk of the plant, and providing a stand to stabilize the plant in a vertical orientation, while optionally providing a source of water or other nutrient solution to the cut end of the trunk, to prolong the inevitable death of the plant after the celebratory period. The present invention is an improvement in a stand intended to position and support the dying plant in a substantially vertical orientation, and to direct water and/or nutrient materials to the trunk.

### BRIEF DESCRIPTION OF THE PRIOR ART

Tree stands of the prior art generally fall into one of two broad categories: collared, and collarless. In a collared stand, an annular ring is affixed to the lower region of the tree trunk, and is adapted to be inserted into, and retained by a stand unit. Such stand units may have a receptacle for water, wherein the collared trunk is permitted to extend downward into the receptacle, and may be provided with stabilizing legs or an annular rim of sufficient diameter to provide stability for the tree. Some collared units have a degree of angular adjustability to allow the orientation of the tree to be adjusted after the collar and stand unit have been attached.

In common collarless stand units, a set of screws (usually either three or four) are part of an annular element at the top of the stand. After the tree is inserted into the stand unit, these screws are advanced inwardly to engage the trunk, often tightened to penetrate the wood to provide a mechanical or interference fit. By advancing and withdrawing one or more screws, the tree may be secured, and its angle relative to vertical may be adjusted. Similar to collared stands, some collarless stands may have a receptacle for water, or may be positioned in a pan adapted to hold a quantity of water and to permit the cut end of the trunk to rest in the pan.

In prior art units, setting the trunk in the stand, securing it, and adjusting it to a substantially vertical position requires reaching under the branches, crawling on the floor, and otherwise lengthy and uncomfortable actions until the tree is fully installed and positioned. There is thus a need for a stand that is simple to operate, easy to adjust, and which requires a minimum amount of awkward position-taking by the person installing the tree, and consequently, a minimum of stress-inducing tension between that person and those who choose to assist or observe his or her activities (typically, “helpful family members.”)

### BRIEF DESCRIPTION OF THE INVENTION

The present invention comprises a base for display of a substantially vertical member, such as a tree, having a supporting generally cylindrical member, such as a trunk, pole or the like. The base is adapted to provide adequate lateral stability to permit the vertical member to remain upright when exposed to lateral forces, to accept and retain liquid, and to allow the liquid to come into contact with the lower end of the cylindrical member. The cylindrical member is retained within the base by interference fit with a member comprised of an expanding, preferably plastic, foam which is initially in an unexpanded state, and is permitted to expand after the cylindrical member is introduced into the base. During expansion of the foam, the cylindrical member is manually maintained in a desired position and orientation, to permit the foam to fill voids and substantially retain the cylindrical member in position after manual support is removed.

### BRIEF DESCRIPTION OF THE FIGURE

FIG. 1 is a section view of the invention.

### DETAILED DESCRIPTION OF THE INVENTION

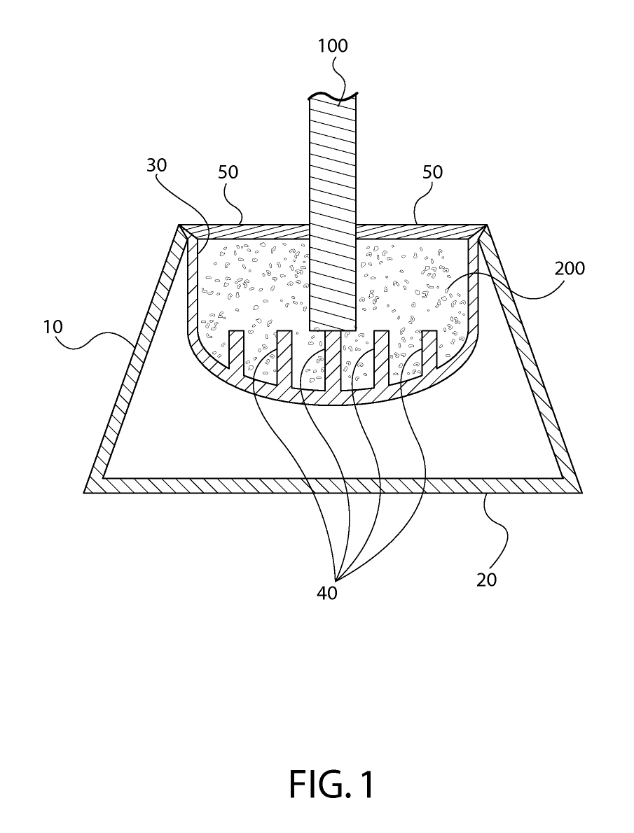

Referring now to FIG. 1, there is shown a section view of the conformable display stand of the present invention. Base 10 comprises a liquid-retaining reservoir, adapted to provide lateral stability. As shown, base 10 is generally circular, with its lower circumferential edge 20 supporting inner convex bowl 30. Alternatively, edge 20 may be augmented by, or replaced by three or more radially disposed leg members (not shown). Bowl 30 is optionally provided with interfering structures 40 on its inner surface. Such structures 40 may be integrally formed with bowl 30, such a prongs, ribs, annular rings, or the like, or may be separately formed and disposed within bowl 30, in a manner so as to provide little or no opportunity for structures 40 to move relative to bowl 30 when in use. Bowl 30 may also be provided with an optional cover 50, having a central annulus of sufficient diameter to permit cylindrical member 100 to pass through cover 50. Bowl 30 may also be provided with a filling apparatus (not shown) to permit liquid (such as water or plant food/preservative to be introduced into bowl 30 from a location distant from bowl 30, by way of a tube or channel in liquid communication with the interior of bowl 30, which may conduct liquid thereto by means of gravity feed, siphon, pump, capillary action or any other known means of liquid transport.

Finally, bowl 30 contains structural foam 200. Foam 200, when in use, fills enough of bowl 30 to provide an interference fit between bowl 30 and the outer surfaces of cylindrical member 100. Alternatively, bowl 30 may be provided with a subcompartment (not shown) that is adapted to accept the structural foam, which would then not fill the entire volume of bowl 30. Prior to use, foam 200 may be separately introduced into bowl 30 (e.g., from a can or other container (not shown), such as is generally available in building trades, and marketed as “Great Stuff” by the Dow Chemical Company or in prepackaged units, such as is generally available for use in packaging, and marketed as “InstaPak Quick” by Sealed Air.)

When an external source of foam is employed, cover 50 is preferably provided with a port or aperture (not shown) to which the foam source may be attached. Alternatively, bowl 30 may be provided with such a port or aperture. When using a prepackaged unit, the foaming chemical reaction may be initiated by manual means prior to positioning of the prepackaged foam unit into bowl 30, or it may be initiated by insertion of cylindrical member 100 into bowl 30.

To use the present invention, base 10 is positioned in the desired location for display. After inspecting to be sure that there is sufficient height available to position cylindrical member 100 in the desired orientation, cylindrical member 100 is inserted into bowl 30, in a generally central location, and in the desired orientation, and foam 200 is allowed to expand within bowl 30 (after introduction as previously described). Cylindrical member 100 may be repositioned during the expansion and curing phase, and is then manually maintained in position for a time interval sufficient for foam 200 to harden, providing an interference fit between base 10 and cylindrical member 100. This process may be accomplished without the need to crawl on the floor or otherwise reach around, beneath or through branches, if cylindrical member 100 is a tree trunk.

When disposal of the display unit is desired, either foam 200 may be removed from bowl 30 and recycled or discarded, or the entire unit may be recycled and discarded. If the display unit is manufactured from a biodegradable plastic material, it may be composed or chipped along with the tree.

The diameter and size of the base of the present invention is selected to be sufficient to counter forces that may be expected to be applied to the item being displayed, such as from wind, ornamentation and other objects placed on the displayed item, as accidental or intentional forces, such as a small child pushing or tripping and falling into the object. Liquid contained in bowl 30 may contribute mass to aid in resistance to such forces.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may be made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority, if any) and that no narrowing of the scope of the appended claims be allowed due to subsequent changes in the law, as such a narrowing would constitute an ex post facto adjudication, and a taking without due process or just compensation.

We claim as our invention:

1. A conformable display stand for supporting an object having a substantially cylindrical base in a desired orientation comprising a base of sufficient diameter and mass to provide a righting moment to counter normally expected lateral forces applied to the object and expandable structural foam contained within the stand, and providing an interference fit between the stand and the cylindrical base of the object.

2. The display stand of claim 1 further comprising a bowl with the stand for containing a liquid in addition to the foam.

3. The display stand of claim 1 wherein the structural foam is introduced into the stand from an external source after the cylindrical base is positioned in the stand.

4. The display stand of claim 1 wherein the structural foam is prepositioned in the stand prior to introduction of the cylindrical base into the stand, and the polymerization foaming reaction is initiated in situ.

5. The display stand of claim 1 further comprising three or more leg members, attached to the stand, and extending outward from the periphery thereof.

6. The display stand of claim 1 further comprising a tube for introducing aqueous matter into the stand from a remote location.

7. The display stand of claim 1 further comprising a channel for introducing aqueous matter into the stand from a remote location.

8. A method for displaying an object having a substantially cylindrical base in a desired orientation comprising inserting the cylindrical base into a display stand base having sufficient diameter and mass to provide a righting moment to counter normally expected lateral forces applied to the object and causing structural foam precursors to react within the stand, expanding in volume to provide an interference fit between the stand and the cylindrical base of the object.
